(19) United States
(12) Patent Application Publication
(10) Pub. No.: US 2006/0155024 A1
(43) Pub. Date: Jul. 13, 2006

(54) Polyvinyl chloride-base thermoplastic elastomer composition

(76) Inventor: Motohiro Suzuki, Gunma (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/563,596

(22) PCT Filed: Jul. 9, 2004
(86) PCT No.: PCT/JP04/10166

§ 371 Date: Jan. 6, 2006

(30) Foreign Application Priority Data
Jul. 10, 2003 (JP) 2003-272695

(51) Int. Cl. C08F 236/12; B29C 47/00

(52) U.S. Cl. 524/297; 524/527

(57) ABSTRACT

To provide a vinyl chloride type thermoplastic elastomer composition which is excellent in shape retention at a high temperature and in the reduction of compression set without lowering the moldability required for a vinyl chloride type resin composition. A vinyl chloride type thermoplastic elastomer composition produced by blending and kneading a pelletized composition (D) obtained by kneading a mixture comprising 100 parts of (A) a vinyl chloride type resin having a high average polymerization degree, from 20 to 200 parts of (B) a plasticizer, and from 50 to 200 parts of (C) a powdered partially crosslinked acrylonitrile/butadiene copolymer, with a powdery mixture (E) obtained by mixing a vinyl chloride type resin having a low average polymerization degree and a plasticizer.

### TECHNICAL FIELD

The present invention relates to a thermoplastic elastomer composition. More particularly, it relates to a vinyl chloride type thermoplastic elastomer composition which has rubber elasticity, whereby an excellent flexible molded product can be obtained, and which has shape retention at a high temperature as the compression set reduced. In the present invention, units such as “parts” representing the proportions in e.g. a composition and “%” representing the constituting ratio of a monomer in the resin, are represented by mass unless otherwise specified.

### BACKGROUND ART

Heretofore, a flexible vinyl chloride type resin composition having a plasticizer incorporated, is excellent in moldability and has been widely used as a material for hoses, building gaskets such as window frames, leathers, films, wire coverings, automobile gaskets such as belt chenille, window chenille and side chenille, etc. However, such a flexible vinyl chloride type resin composition has had a drawback such that as compared with vulcanized rubber, the shape retention at a high temperature or the compression set is remarkably poor.

As a method to overcome such a drawback, there is, for example, a means of using a vinyl chloride resin having an average polymerization degree of from 2,000 to 4,000 as measured by JIS K 6720-2. When a vinyl chloride resin having an average polymerization degree within this range, is used, the value of the compression set as measured under the conditions of 70° C.×22 hr in accordance with JIS K 6262, decreases to a level of about 55%. Here, the value of the compression set in a case where vinyl chloride type resin having an average polymerization degree of less than 2,000 is used, the value of the compression set is from 60 to 70%. However, this is still inadequate as a material for hoses, building gaskets such as window frames, leathers, films, wire coverings, and automobile gaskets such as belt chenille, window chenille and side chenille, which require a further lower excellent compression set. Further, even if a vinyl chloride type resin having an average polymerization degree exceeding 4,000, is used, it is impossible to reduce the compression set to a level of at most 50%, and not only that, there has been a drawback that the moldability of the flexible vinyl chloride type resin composition tends to deteriorate.

Accordingly, as a method to improve the moldability and further reduce the compression set, it is common to employ a method of adding a partially crosslinked acrylonitrile/butadiene copolymer to a vinyl chloride type resin composition comprising a vinyl chloride resin and a plasticizer (e.g. JP-A-07-196849 and JP-A-08-225699). However, in a case where the average polymerization degree of the vinyl chloride type resin is low or in a case where the amount of the partially crosslinked acrylonitrile/butadiene copolymer added, is small, the moldability may be good, but no substantial improvement will be obtained in the shape retention at a high temperature or in reduction of the compression set. Inversely, in a case where the average polymerization degree of the vinyl chloride type resin is high or in a case where the amount of the partially crosslinked acrylonitrile/butadiene copolymer added is large, the shape retention at a high temperature or the reduction of compression set may be improved, but the moldability tends to be poor. Namely, such a method has been inadequate in order to simultaneously satisfy the required moldability, the shape retention at a high temperature and reduction of the compression set.

### DISCLOSURE OF THE INVENTION

It is an object of the present invention to provide a vinyl chloride type thermoplastic elastomer composition which provides shape retention at a high temperature and which is excellent in reduction of the compression set without lowering the moldability required for the vinyl chloride type resin composition.

As a result of an extensive study to solve the above-mentioned problems, the present inventors have found it possible to obtain a vinyl chloride type thermoplastic elastomer with all of the above-mentioned problems solved by blending and kneading a pelletized composition having sufficient rubber elasticity obtained by kneading a mixture comprising a vinyl chloride type resin having a high average polymerization degree, a plasticizer and a powdered partially crosslinked acrylonitrile/butadiene copolymer, with a powdery mixture obtained by mixing a vinyl chloride type resin having a low average polymerization degree and a plasticizer, and have arrived at the present invention.

Namely, the present invention provides a vinyl chloride type thermoplastic elastomer composition produced by blending and kneading a pelletized composition (D) obtained by kneading a mixture comprising 100 parts of (A) a vinyl chloride type resin having a high average polymerization degree, from 20 to 200 parts of (B) a plasticizer, and from 50 to 200 parts of (C) a powdered partially crosslinked acrylonitrile/butadiene copolymer, with a powdery mixture (E) obtained by mixing a vinyl chloride type resin having a low average polymerization degree and a plasticizer. The average polymerization degree of (A) the vinyl chloride type resin is preferably from 1,700 to 4,000. Further, (C) the powdered partially crosslinked acrylonitrile/butadiene copolymer is preferably a copolymer comprising from 20 to 45% of acrylonitrile and from 80 to 55% of butadiene, wherein a methyl ethyl ketone insoluble content is from 20 to 95%. Further, the average polymerization degree of vinyl chloride type resin in the powdery mixture (E) contained by mixing the vinyl chloride type resin and the plasticizer, is from 1,000 to 1,500.

By the present invention, it is possible to provide a vinyl chloride type thermoplastic elastomer composition which provides a shape retention property at a high temperature and which is excellent in reduction of the compression set, without lowering the moldability of the vinyl chloride type resin composition.

### BEST MODE FOR CARRYING OUT THE INVENTION

Now, the present invention will be described in detail. As (A) the vinyl chloride type resin having a high average polymerization degree to be used in the present invention, a resin may be used which is obtained by polymerizing a vinyl chloride monomer or a mixture of a vinyl chloride monomer with another monomer copolymerizable therewith by a usual method such as a suspension polymerization method, a bulk polymerization method or a finely suspended polymerization method. It is preferably a vinyl chloride type resin by a suspension polymerization method, which is excellent in blending with a plasticizer.

Another monomer copolymerizable with the vinyl chloride monomer may, for example, be an olefin such as ethylene or propylene; a vinyl ester such as vinyl acetate or vinyl stearate; a vinyl ether such as methyl vinyl ether or lauryl vinyl ether; an ester of acrylic acid or methacrylic acid, such as methyl acrylate or methyl methacrylate; an amino or nitrile, such as methacrylamid or acrylonitrile; a styrene such as styrene or α-methylstyrene; or a polyfunctional monomer such as diallyl phthalate or ethylene glycol dimethacrylate.

As such a vinyl chloride type resin (A), it is preferred to employ one having a high average polymerization degree. The average polymerization degree as measured by JIS K 6720-2 is preferably from 1,500 to 5,000, more preferably from 1,700 to 4,000, most preferably from 2,500 to 3,800. If the average polymerization degree is less than 1,500, no adequate rubber elasticity can be imparted to the pelletized composition (D), and a molded product of the vinyl chloride type thermoplastic elastomer composition produced by blending and kneading it with the powdery mixture (E) obtained by mixing a vinyl chloride type resin having a low average polymerization degree with a plasticizer, tends to have a poor shape retention property at a high temperature. On the other hand, if the average polymerization degree exceeds 5,000, the melt viscosity during the molding tends to be remarkably high; the moldability tends to be poor; the desired rubber elasticity cannot be imparted, and further, there will be a problem that the surface of a molded product tends to be roughened.

(B) The plasticizer to be used in the present invention is not particularly limited. Like in the case of conventional flexible vinyl chloride type resin compositions, one or more may be used from, for example, a phthalate such as bis(2-ethylhexyl) phthalate or diisononyl phthalate; an adipate such as bis(2-ethylhexyl) adipate, diisononyl adipate or di-n-alkyl adipate; a sebacate such as dibutyl sebacate; a trimellitate such as tris(2-ethylhexyl) trimellitate; and a polyester such as an adipic acid type polyester or a phthalic acid type polyester.

The amount of (B) the plasticizer is from 20 to 200 parts per 100 parts of (A) the vinyl chloride resin. If it is less than 20 parts, the melt viscosity tends to be high at the time of producing the pelletized composition (D) whereby upon receipt of a substantial thermal history, the pelletized composition is likely to undergo a color change due to thermal degradation. If the above amount exceeds 200 parts, the plasticizer is likely to bleed out from the pelletized composition (D), whereby the pelletized composition is likely to adhere and be unified. The unified pelletized composition (D) tends to be hardly dispersed in the powdery mixture (E) obtained by mixing a vinyl chloride type resin having a low average polymerization degree with a plasticizer, and there will be a problem such that various physical properties of a molded product of the obtainable vinyl chloride type thermoplastic elastomer composition tend to be unstable.

In the vinyl chloride type thermoplastic elastomer in the present invention, a filler may be added to the pelletized composition (D) and/or the powdery mixture (E) for the purpose of improving the required physical properties and processability. When the filler is to be added, the filler may be preliminarily added to the pelletized composition (D) and/or the powdery mixture (E), followed by kneading, or it may be added at the time of kneading the pelletized composition (D) and the powdery mixture (E).

Such a filler may, for example, be calcium carbonate, talc, silica, clay, aluminum hydroxide, magnesium hydroxide or antimony oxide. Among them, calcium carbonate and/or talc is preferred with a view to substantially improving the shaping property during the molding of the vinyl chloride type resin composition. Here, calcium carbonate may be either calcium carbonate heavy or calcium carbonate light.

The amount of the filler to be used is not particularly limited, but it is usually preferably within a range of at most 50% in the vinyl chloride type thermoplastic elastomer composition of the present invention. If the amount exceeds 50%, the surface of the molded product will not sometimes be smooth.

The powdered partially crosslinked acrylonitrile/butadiene copolymer (C) to be used in the present invention is preferably one comprising from 20 to 45% of acrylonitrile and from 80 to 55% of butadiene, more preferably one comprising from 30 to 40% of acrylonitrile and from 60 to 70% of butadiene. If the content of acrylonitrile is less than 20% or more than 45%, the compatibility with the vinyl chloride type resin composition tends to be low, and the mechanical strength tends to decrease. The Mooney viscosity is preferably from 20 to 120, more preferably from 30 to 60 by ML1+4 (100° C.). Further, it is necessary to employ a partially crosslinked acrylonitrile/butadiene copolymer, and the crosslinked degree is preferably such that the methyl ethyl ketone insoluble content is preferably from 20 to 95%, more preferably from 40 to 95%. If the insoluble content is less than 20%, the effect to improve the rubber elasticity or compression set of a molded product of the vinyl chloride type thermoplastic elastomer composition of the present invention tends to be low, and in the case of a molded sheet product, the sheet tends to undergo shrinkage, and the surface smoothness may sometimes be lost. On the other hand, if the insoluble content exceeds 95%, elongation of the molded product tends to be low.

The amount of (C) the powdered partially crosslinked acrylonitrile/butadiene copolymer to be used, is from 50 to 200 parts, more preferably from 70 to 150 parts, per 100 parts of (A) the vinyl chloride type resin. If the amount is less than 50 parts, the object of the present invention will not be accomplished with respect to the rubber elasticity, the shape retention property at a high temperature and the compression set characteristic of the obtained elastomer composition. If the amount exceeds 200 parts, the melt viscosity tends to be remarkably high at the time of preparing the pelletized composition, whereby the shape of pellets tends to be irregular or the composition can hardly be pelletized.

The average particle diameter of (C) the powdered acrylonitrile/butadiene copolymer is preferably at most 5 mm, more preferably at most 1 mm. If the average particle diameter exceeds 5 mm, adequate uniform kneading tends to be difficult. The powdering is carried out in such a manner that a partially crosslinked acrylonitrile/butadiene copolymer produced by usual emulsion polymerization is taken out as a dried product in a flake or vail form and then pulverized to a necessary size by freeze pulverization or mechanical pulverization. The pulverized product is susceptible to blocking, and calcium carbonate or the like is added as an antiblocking agent. The amount of the antiblocking agent to be added is not particularly limited, but it is usually preferably at most 30 parts per 100 parts of the partially crosslinked acrylonitrile/butadiene copolymer. If it exceeds 30 parts, the mechanical strength tends to decrease.

In the present invention, the methyl ethyl ketone insoluble content in the partially crosslinked acrylonitrile/butadiene copolymer is such that 50 cc of methyl ethyl ketone is put in 1 g of a sample, and after being left at room temperature for 24 hours, the sample is shaked for one hour and then subjected to centrifugal separation at 10,000 rpm for 90 minutes, whereupon the insoluble is vacuum-dried, and a percentage of a value obtained by dividing the weight of the insoluble by the weight of the sample is taken as the methyl ethyl ketone insoluble.

As mentioned above, the vinyl chloride type thermoplastic elastomer composition of the present invention is produced by blending and kneading a pelletized composition (D) preferably having an average size (length) of preferably from 1 to 8 mm, particularly preferably from 1 to 5 mm, obtained by kneading a mixture comprising (A) the vinyl chloride type resin, (B) the plasticizer, and (C) the powdered partially crosslinked acrylonitrile/butadiene copolymer, with a powdery mixture (E) obtained by mixing a vinyl chloride type resin and a plasticizer. The vinyl chloride type resin and the plasticizer to be used for the powdery mixture (E) are not particularly limited. However, a vinyl chloride type resin having an average polymerization degree of preferably from 800 to 1,500, more preferably from 1,000 to 1,500, is suitable. As the plasticizer, a phthalate, a trimellitate or a polyester is, for example, preferably used. Further, the average particle diameter of the powdery mixture (E) is preferably from 100 to 2,000 μm, particularly preferably from 200 to 1,000 μm.

The blend ratio of the above-mentioned pelletized composition (D) to the powdery mixture (E) obtained by mixing the vinyl chloride type resin and the plasticizer, varies depending upon the type of the elastomer composition intended by the present invention. However, the ratio of (D)/(E) is preferably from 5/95 to 95/5, particularly preferably from 10/90 to 50/50. As an effect of the present invention obtainable by blending such a pelletized composition (D) with the powdery mixture (E), although the reason is not clearly understood, by mixing the pelletized composition having sufficient rubber elasticity with the composition so-called a general purpose flexible vinyl chloride type resin composition, good moldability of the general purpose flexible vinyl chloride type resin composition can be imparted without substantially losing the characteristics of the composition having rubber elasticity.

To the pelletized composition (D) and/or the powdery mixture (E) obtained by mixing the vinyl chloride type resin and the plasticizer, of the present invention, various additives, such as a thermoplastic resin excellent in compatibility with a vinyl chloride type resin, such as an ethylene/vinyl acetate copolymer, an acrylic resin, a chlorinated polyethylene, a polyurethane or an acrylonitrile/butadiene copolymer, a flame retardant represented by antimony trioxide or zinc borate, which is commonly added to a vinyl chloride type resin, a thermal stabilizer such as barium stearate, zinc stearate or tribasic lead sulfate, an antioxidant, an ultraviolet absorber, a lubricant and a colorant, may be added as the case requires within a range not to substantially decrease the respective performances.

The methods for mixing, kneading and pelletizing various components constituting the vinyl chloride type thermoplastic elastomer composition of the present invention, or the method for molding the obtained vinyl chloride type thermoplastic elastomer composition is not particularly limited, and common mixing, kneading and pelletizing methods and molding methods may be employed.

As the mixing machine, a high speed mixer such as Henschel mixer or a super mixer, or a ribbon blender may, for example, be used. As a kneading machine, an open roll, a closed type kneader (such as a Banbury mixer or a pressure type kneader), a common single screw extruder, a co-kneader, a co-rotating twin screw extruder, a counter-rotating twin screw extruder, a kneader ruder type high speed stirring extruder or a plastificator which is a kneading extruder having a structure wherein a conical rotor having a plurality of grooves on its surface, is combined with a barrel having a recess corresponding to the contour of the rotor and having a plurality of grooves on the recess side surface (manufactured by WERNER & PFLEIDER COMPANY) may, for example, be used. For pelletizing, a usual hot cut pelletizer, a cold pelletizer or a sheet pelletizer may be used.

Now, the present invention will be described in further detail with reference to Examples.

### EXAMPLE 1

In the ratio as shown in Table 1, (A) the vinyl chloride resin having a high average polymerization degree, (B) the plasticizer and other additives, and (C) the powdered partially crosslinked acrylonitrile/butadiene copolymer were put into a 75 L Henschel mixer and stirred at a high speed (1640 rpm), and stirring was stopped when the temperature of the content reached 100° C. The content was taken out and kneaded by a 40 mm co-kneader to obtain a pelletized composition (D) having an average size of 3 mm.

A vinyl chloride resin having a low average polymerization degree, the plasticizer and other additives were put into a 75 L Henschel mixer and stirred at a high speed, and stirring was stopped when the temperature of the powdery mixture (E) reached 100° C. Water was supplied to the jacket, and the content was cooled by stirring at a low speed (820 rpm) and when it became 70° C., the pelletized composition (D) was added, and stirring and cooling were continued, and when it reached 40° C., the content was taken out.

The pelletized composition (D) and the powdery mixture (E) were blended in a mixing weight ratio of 1:1. The content was pelletized by a 40 mm co-kneader to obtain a vinyl chloride type thermoplastic elastomer composition of the present invention, which was used as a sample for evaluation of the vinyl chloride type thermoplastic elastomer composition. The results of the evaluation by the after-mentioned test methods are shown in Table 1. The compression set was small, and the moldability and the high temperature shape retention property were good.

In Table 1, Examples 1 to 4 are Examples of the present invention, and Examples 5 to 8 are Comparative Examples.

TABLE 1

| | | | Example | | | | | | | |
|---|---|---|---|---|---|---|---|---|---|---|
| | | | Nos. | | | | | | | |
| | | | 1 | 2 | 3 | 4 | 5 | 6 | 7 | 8 |
| Blend | Pelletized | (A) | 35 | 100 | 100 | | 100 | | 100 | 100 |
| | composition D | Vinyl chloride | parts | parts | parts | | parts | | parts | parts |
| | | resin 1 | | | | | | | | |
| | | Vinyl chloride | 65 | | | | | | | |
| | | resin 2 | parts | | | | | | | |
| | | Vinyl chloride | | | | 100 | | | | |
| | | resin 3 | | | | parts | | | | |
| | | Vinyl chloride | | | | | | | | |
| | | resin 4 | | | | | | | | |
| | | (B) Plasticizer 1 | 100 | 100 | 100 | 100 | 100 | | 100 | 100 |
| | | | parts | parts | parts | parts | parts | | parts | parts |
| | | (c) Partially | 100 | 100 | 100 | 100 | 100 | | 100 | |
| | | crosslinked NBR | parts | parts | parts | parts | parts | | parts | |
| | | Non-crosslinked NBR | | | | | | | | 100 |
| | | | | | | | | | | parts |
| | | Filler 1 | 50 | 50 | 50 | 50 | 50 | | 50 | 50 |
| | | | parts | parts | parts | parts | parts | | parts | parts |
| | | Thermal stabilizer 1 | 3 | 3 | 3 | 3 | 3 | | 3 | 3 |
| | | | parts | parts | parts | parts | parts | | parts | parts |
| | | Thermal stabilizer 2 | 3 | 3 | 3 | 3 | 3 | | 3 | 3 |
| | | | parts | parts | parts | parts | parts | | parts | parts |
| Blend | Powdery | Vinyl chloride | 100 | 100 | | | | 100 | 100 | 100 |
| | mixture E | resin 3 | parts | parts | | | | parts | parts | parts |
| | | Vinyl chloride | | | 100 | 100 | | | | |
| | | resin 4 | | | parts | parts | | | | |
| | | Plasticizer 1 | 65 parts | 65 | 65 | 65 | | 50 | 65 | 65 |
| | | | | parts | parts | parts | | parts | parts | parts |
| | | Thermal | 2 parts | 2 | 2 | 2 | | 2 | 2 | 2 |
| | | stabilizer 1 | | parts | parts | parts | | parts | parts | parts |
| | | Thermal | 1 part | 1 | 1 | 1 | | 1 part | 1 part | 1 part |
| | | stabilizer 2 | | part | part | part | | | | |
| Vinyl | Blend | Composition D | 100 parts | 100 | 100 | 100 | 100 | — | 100 | 100 |
| chloride | ratio | | (Pelletized) | parts | parts | parts | parts | | parts | parts |
| type | | | | ( [symbol] ) | ( [symbol] ) | ( [symbol] ) | ( [symbol] ) | | (Powdery) | (Pelletized) |
| thermo- | | Composition E | 100 parts | 100 | 100 | 100 | — | 100 | 100 | 100 |
| plastic | | | (Powdery) | parts | parts | parts | | parts | parts | parts |
| elastomer | | | | ( [symbol] ) | ( [symbol] ) | ( [symbol] ) | | (Powdery) | ( [symbol] ) | ( [symbol] ) |
| | Evaluation | Compression | 52 | 49 | 51 | 58 | 40 | 63 | 50 | 61 |
| | | set (%) | | | | | | | | |
| | | Moldability | ⊚ | ◯ | ⊚ | ⊚ | X | ◯ | X | Δ |
| | | High | ◯ | ⊚ | ◯ | Δ | ◯ | X | Δ | X |
| | | temperature | | | | | | | | |
| | | shape | | | | | | | | |
| | | retention | | | | | | | | |
| | | property | | | | | | | | |

| | | | | | | | | |
|---|---|---|---|---|---|---|---|---|
| Note | Ex. | Ex. | Ex. | Ex. | Comp. | Comp. | Comp. | Comp. |
| | | | | | Ex. | Ex. | Ex. | Ex. |

Materials Used

Vinyl chloride type resin 1: average polymerization degree 3,800

Vinyl chloride type resin 2: average polymerization degree 2,500

Vinyl chloride type resin 3: average polymerization degree 1,500

Vinyl chloride type resin 4: average polymerization degree 1,000

Powdered partially crosslinked

acrylonitrile/butadiene copolymer

Partially crosslinked NBR: containing 15% of calcium carbonate “NS-400” manufactured by NITTO FUNKA KOGYO K.K., as an antiblocking agent; particle diameter: at most 1 mm; acrylonitrile content: 40%; butadiene content: 60%; methyl ethyl ketone insoluble content: 83%; ML1+4 (100° C.): 60

Non-crosslinked NBR: containing 15% of calcium carbonate “NS-400”, manufactured by NITTO FUNKA KOGYO K.K., as an antiblocking agent; particle diameter: at most 1 mm; acrylonitrile content: 35%; butadiene content: 65%; methyl ethyl ketone insoluble content: 0%; ML1+4 (100° C.): 55

Plasticizer 1: commercial product, bis(2-ethylhexyl) phthalate

Filler 1: commercial product, calcium carbonate “NS-400”, manufactured by NITTO FUNKA KOGYO K.K.

Thermal stabilizer 1: commercial product, epoxydized soybean oil “Adekasizer 0-130P”, manufactured by ASAHI DENKA CO., LTD

Thermal stabilizer 2: commercial product, barium zinc type composite stabilizer “Adecastub AC183”, manufactured by ASAHI DENKA CO., LTD

Test Methods

Evaluation of Compression Set

In accordance with JIS K6262, evaluation of the compression set was carried out under testing conditions of 70° C. for 22 hours.

Evaluation of Moldability

Using a 40 m/m single screw extruder, tube extrusion was carried out at a die temperature of 170° C., whereby evaluation of the extrusion moldability was carried out. ⊚ indicates a case where the surface of the molded product is smooth, and the shape is good; ◯ indicates a case where the surface of the molded product is flat but roughened; Δ indicates a case where waving is observed on the surface of the molded product, and the surface is not flat; and X indicates a case where waving is observed on the surface of the molded product, and the molded product having a dimension corresponding to the shape of the die is not obtained.

Evaluation of High Temperature Shape Retention Property

A tube obtained by extrusion molding was horizontally kept in a gear oven of 170° C. for 30 minutes, whereby the shape of the tube was evaluated by the following formula (1).

(1) High temperature shape retention (%)=(smallest contour height (mm) at a flattened portion of the tube/outer diameter (mm) of the tube before being put in the gear oven)×100

⊚ indicates a case where the high temperature shape retention by the formula (1) is at least 90%; ◯ indicates a case where it is at least 70% and less than 90%; Δ indicates a case where it is at least 50% and less than 70%; X indicates a case where it is less than 50%.

### EXAMPLE 2

The desired vinyl chloride type thermoplastic elastomer composition was obtained under the same conditions as in Example 1 except that the blend materials as shown in Table 1 were used, and its evaluation was carried out. The results are shown in Table 1. The compression set was small, and the moldability and the high temperature shape retention were good.

### EXAMPLE 3

The desired vinyl chloride type thermoplastic elastomer composition was obtained under the same conditions as in Example 1 except that the blend materials as shown in Table 1 were used, and its evaluation was carried out. The results are shown in Table 1. The compression set was small, and the moldability and the high temperature shape retention were good.

### EXAMPLE 4

The desired vinyl chloride type thermoplastic elastomer composition was obtained under the same conditions as in Example 1 except that the blend materials as shown in Table 1 were used, and its evaluation was carried out. The results are shown in Table 1. As shown by the evaluation results in Table 1, since the average polymerization degree of the vinyl chloride type resin used for the pelletized composition was as low as 1,500, the moldability of the vinyl chloride type thermoplastic elastomer was good, but as compared with Examples 1 to 3, the effect for improvement in the compression set and the high temperature shape retention was small.

### EXAMPLE 5

Using the blend materials as shown in Table 1, a pelletized composition (D) was obtained under the same conditions as Example 1. This composition was per se (without adding the powdery composition (E)) subjected to the same evaluation as in Example 1. The results are shown in Table 1. The moldability was very poor, and the object of the present invention was not satisfied.

### EXAMPLE 6

Using the blend materials as shown in Table 1, a powdery composition (E) was obtained under the same conditions as in Example 1. This composition was per se (without adding the pelletized composition (D)) subjected to the same evaluation as in Example 1. The results are shown in Table 1. This Example 6 represents a conventional flexible vinyl chloride type composition, whereby the moldability was good, but the compression set and the high temperature shape retention were very poor.

### EXAMPLE 7

The blend materials as shown in Table 1 were used. Without pelletizing the composition (D), the desired vinyl chloride type thermoplastic elastomer composition was obtained under the same conditions as in Example 1, and its evaluation was carried out. The results are shown in Table 1. The moldability was very poor, and improvement in the high temperature shape retention was little.

### EXAMPLE 8

The desired vinyl chloride type thermoplastic elastomer composition was obtained under the same conditions as in Example 1 except that a partially non-crosslinked NBR was used as shown in Table 1, and its evaluation was carried out. The results are shown in Table 1. The moldability was poor, and the compression set and the high temperature shape retention were very poor.

1. A vinyl chloride type thermoplastic elastomer composition produced by blending and kneading a pelletized composition (D) obtained by kneading a mixture comprising:
100 parts of (A) a vinyl chloride type resin having a high average polymerization degree,
from 20 to 200 parts of (B) a plasticizer, and
from 50 to 200 parts of (C) a powdered partially crosslinked acrylonitrile/butadiene copolymer, with a powdery mixture (E) obtained by mixing a vinyl chloride type resin having a low average polymerization degree and a plasticizer.

2. The vinyl chloride type thermoplastic elastomer composition according to claim 1, wherein the average polymerization degree of (A) the vinyl chloride type resin is from 1,700 to 4,000.

3. The vinyl chloride type thermoplastic elastomer composition according to claim 1, wherein (C) the powdered partially crosslinked acrylonitrile/butadiene copolymer is a copolymer comprising:
from 20 to 45% of acrylonitrile; and from 80 to 55% of butadiene, wherein a methyl ethyl ketone insoluble content is from 20 to 95%.

4. The vinyl chloride type thermoplastic elastomer composition according to claim 1, wherein the average polymerization degree of the vinyl chloride type resin in the powdery mixture (E) obtained by mixing the vinyl chloride type resin and the plasticizer, is from 800 to 1,500.

5. The vinyl chloride type thermoplastic elastomer composition according to claim 1, wherein a blend ratio (mass ratio) of the pelletized composition (D) to the powdery mixture (E) is from 5/95 to 95/5.

6. The vinyl chloride type thermoplastic elastomer composition according to claim 1, wherein an average size of the pelletized composition (D) is from 1 to 8 mm, and an average particle diameter of the powdery mixture (E) is from 100 to 2,000 μm.
